(19) United States
(12) Patent Application Publication
(10) Pub. No.: US 2026/0292448 A1
(43) Pub. Date: Sep. 24, 2026

(54) LOW POWER DEEP SLEEP FOR DEVICES IN WIRELESS NETWORKS

(71) Applicant: Cypress Semiconductor Corporation, San Jose, CA (US)

(72) Inventors: Abhik Chitta Ghanti, Barddhaman (IN); Vinoth Sampath, Bangalore, IN (US); Chaitanya Sandeep Gaikwad, Pune (IN)

(73) Assignee: Cypress Semiconductor Corporation, San Jose, CA (US)

(21) Appl. No.: 19/190,148

(22) Filed: Apr. 25, 2025

Related U.S. Application Data
(60) Provisional application No. 63/774,276, filed on Mar. 19, 2025.

(51) Int. Cl. H04W 4/12; H04L 5/00; H04W 8/22; H04W 76/25

(52) U.S. Cl. CPC H04W 4/12; H04L 5/0053; H04W 8/22; H04W 76/25

(57) ABSTRACT

A method, a system, and an apparatus are provided. The apparatus receives, from a station (STA) device, a first request to start a proxy service for a communication session between the STA device and a server. The apparatus transmits, to the STA device, a first response that acknowledges the first request. The apparatus obtains, from the STA device, initial context information associated with the communication session. The apparatus transmits, to the server and on behalf of the STA device, a message that indicates continuation of the communication session.

### CROSS-REFERENCE TO RELATED APPLICATIONS

This application claims priority to U.S. Provisional Patent Application No. 63/774,276, filed Mar. 19, 2025, the disclosure of which is incorporated by reference in its entirety.

### TECHNICAL FIELD

The present disclosure relates generally to telecommunications, and more particularly, to low power deep sleep for devices in a wireless network.

### BACKGROUND

In some wireless systems, such as those relating to the Institute of Electrical and Electronics Engineers (IEEE) 802.11 standards, an access point (AP) provides a wireless network for other devices, such as station (STA) devices, to receive and transmit data, e.g., in wireless communication sessions with a server. To reduce power consumption, some STA devices, such as battery-powered Internet-of-Things (IoT) devices, may enter a deep sleep mode. For example, an STA device may enter a basic service set (BSS) max idle period or a wireless network management (WNM) sleep mode, in which the STA device turns off some wireless functions, e.g., Layer 2 (L2) functions, for a duration up to several hours.

### BRIEF DESCRIPTION OF THE DRAWINGS

The present disclosure is illustrated by way of example, and not by way of limitation, in the figures of the accompanying drawings in which like reference numerals refer to similar elements.

FIGS. 1A and 1B each illustrate an application of a wireless network, according to some implementations.

FIGS. 2A-2B each illustrate a scenario in which an STA device enters deep sleep that causes interruption of communication.

FIG. 3 is a diagram that illustrates a procedure for configuring offloads between an STA device and an AP, according to some implementations.

FIGS. 4A-4E are diagrams that each illustrate a procedure for power saving based on based on alignment of triggering events, according to some implementations.

FIGS. 5A-5C are diagrams that together illustrate a procedure of providing a proxy service to an STA device, according to some implementations.

FIGS. 6A-6B are diagrams that together illustrate another procedure of providing a proxy service to an STA device, according to some implementations.

FIGS. 6C-6D are diagrams that together illustrate yet another procedure of providing a proxy service to an STA device, according to some implementations.

FIG. 7 is a flowchart that illustrates a method of power management in deep sleep based on triggering events, according to some implementations.

FIG. 8 is a flowchart that illustrates a method of providing a proxy service to an STA device, according to some implementations.

FIG. 9 is a block diagram of an example apparatus that may perform one or more of the operations described herein, according to some implementations.

### DETAILED DESCRIPTION

The following description sets forth numerous specific details such as examples of specific systems, components, methods, and so forth, in order to provide a good understanding of various implementations of the techniques described herein. It will be apparent to one skilled in the art, however, that at least some implementations may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

When an STA device is in the deep sleep mode, the L2 functions may remain inactive for up to several hours. Meanwhile, the STA device may also be executing some upper layer functions in a communication session, such as a session under the transmission control protocol (TCP) session or the user datagram protocol (UDP), with a server or another STA device. To maintain continuity of the session, the protocol expects the STA device to perform regular handshake communications (e.g., exchange messages to indicate continuation of the session) during the several hours of deep sleep. In other cases, the STA device may rely on a network address assigned by the server (e.g., leased to the STA device) under the dynamic host configuration protocol (DHCP) to perform communications, and the server expects the STA device to regularly send messages (e.g., one or more frames) to renew the lease during the several hours of deep sleep. As such, the STA device may need to wake up (e.g., exit the deep sleep mode) frequently by reactivating the turned-off functions. The frequent wake-ups are usually power-consuming and may negatively affect the STA device's performance, especially when the STA device is a battery powered IoT device.

Implementations of this disclosure address the above challenges. As described in detail below, implementations of this disclosure provide techniques that allow the STA device to remain in the deep sleep mode for a longer period of time while maintaining continuity of communication sessions. With one or more features described below, an STA device may have improved power efficiency and provide improved communication performance.

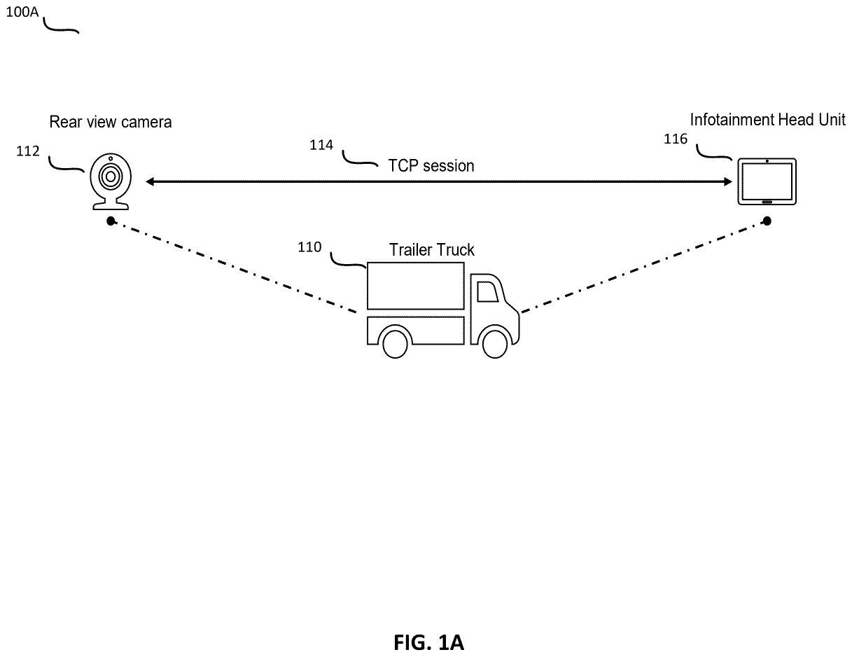

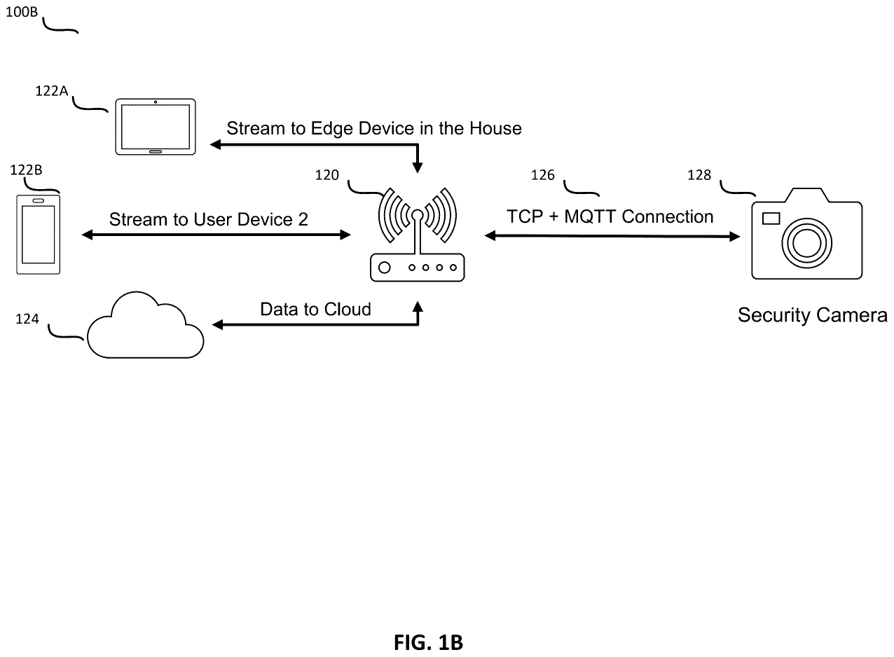

FIGS. 1A and 1B each illustrate an application of a wireless network, according to some implementations. Wireless network 100A in FIG. 1A is applied to a trailer truck 110 equipped with a rear view camera 112 and an infotainment head unit 116 that displays the images captured by rear view camera 112. Wireless network 100B in FIG. 1B is applied to a smart home security system that, upon detecting a security event, uses security camera 128 to capture images at the home vicinity and uses transmitter 120 to send the captured images to user devices 122A and 122B and to cloud 124.

In FIG. 1A, rear view camera 112 transmits the captured images to infotainment head unit 116 wirelessly via TCP session 114. Both rear view camera 112 and infotainment head unit 116 may be battery powered STA devices in communication with an AP located on trailer truck 110. In a typical scenario, rear view camera 112, upon receiving a signal from the AP based on an instruction from the operator of trailer truck 110, starts streaming captured images to infotainment head unit 116 to assist the operator in maneuvering trailer truck 110. While rear view camera 112 may be in the deep sleep mode for a long period of time to save power, it is usually desirable to maintain continuity of TCP session 114 so the streaming can start as soon as the operator sends the instruction.

In FIG. 1B, security camera 128 streams the captured images to transmitter 120 wirelessly via TCP and message queuing telemetry transport (MQTT) session 126, which then sends the images to user devices 122A, 122B, and/or cloud 124 to alert the user (e.g., homeowner) of a security event. While security camera 128 may remain in the deep sleep mode for a long period of time and activate only upon detecting a security event (e.g., an object moving within the home vicinity), it is usually desirable to maintain continuity of TCP and MQTT session 126 so the streaming can start as soon as the security event is detected.

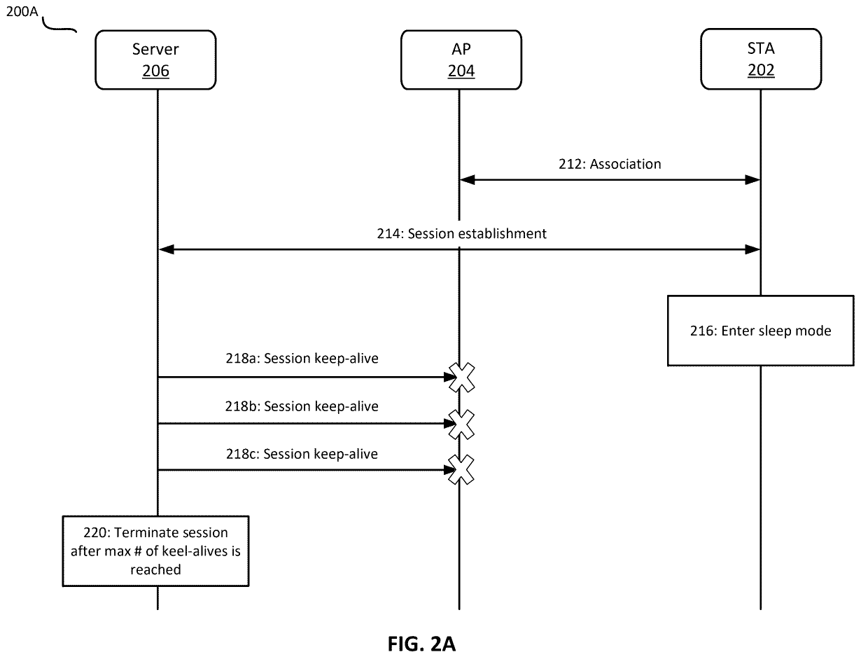

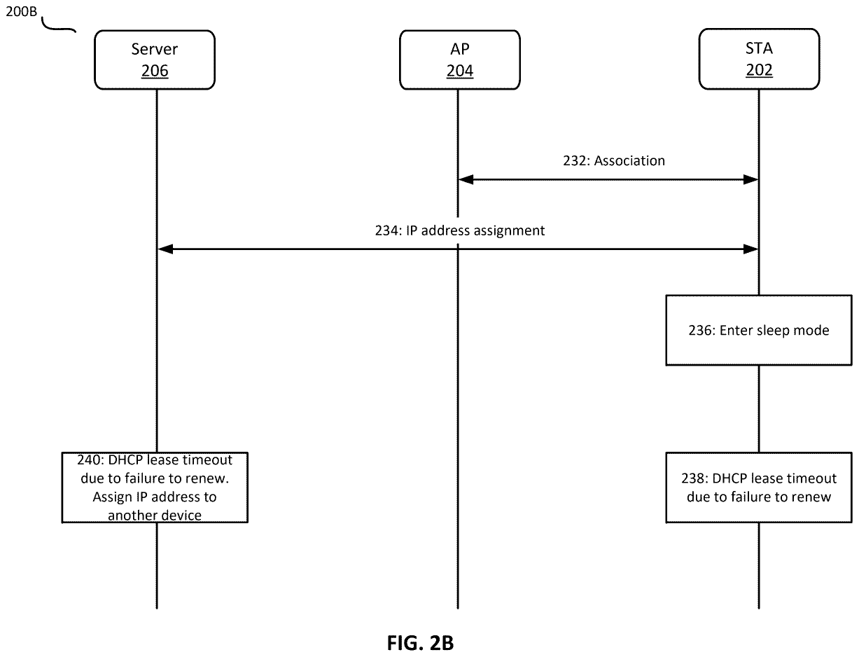

FIGS. 2A-2B each illustrate a scenario in which an STA device enters deep sleep that causes interruption of communication. Scenarios 200A and 200B illustrated in FIGS. 2A and 2B, respectively, involve STA device 202, AP 204 (which may be a hardware AP device or a software-enabled AP (soft AP)), and server 206.

In scenario 200A, STA device 202 associates with AP 204 at 212 and establishes a communication session, e.g., a TCP session, with server 206 at 214. STA device 202 then enters the deep sleep mode at 216. During the sleep of STA device 202, server 206 attempts to handshake with STA device 202 by transmitting multiple session keep-alive messages 218a-218c to AP 204 and expects to receive an acknowledgement. However, because STA device 202 is in the deep sleep mode, STA device 202 fails to respond to the handshake request, which causes AP 204 to fail to acknowledge session keep-alive messages 218a-218c. As a result, after the number of un-acknowledged session keep-alive messages reaches a maximum number (e.g., 3), server 206 decides to terminate the session, even if STA device 202 desires to maintain continuity of the session.

Similarly, in scenario 200B, STA device 202 associates with AP 204 at 232 and leases an internet protocol (IP) address (e.g., a DHCP IP address) from server 206 (e.g., a DHCP server) at 234. STA device 202 then enters the deep sleep mode at 236. During the sleep of STA device 202, the lease for the IP address expires and STA device 202 fails to renew the IP address with server 206. As a result, server 206 may revoke the IP address from STA device 202 and assign the IP address to another device, even if STA device 202 desires to retain the IP address for a longer period of time.

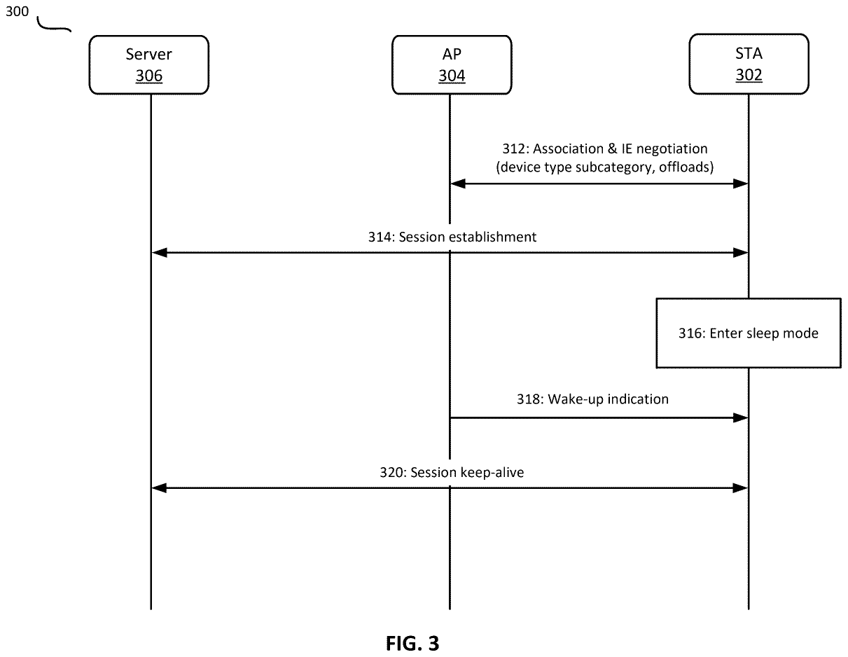

To avoid the problems in scenarios 200A and 200B, there needs to be a power-efficient mechanism to send the session keep-alive messages (in the case of scenario 200A) or renew the leased IP address (in the case of scenario 200B) after STA device 202 enters the sleep mode. In some implementations, this is achieved by the AP waking up the STA device according to one or more timers configured based on the wakeup schedule and/or session information configurations (“offload configurations”) such that the STA device may process multiple time-sensitive events at once, thereby reducing the number of wake-ups and saving power. Alternatively, or additionally, this is achieved by the STA device utilizing a proxy service provider, which may be the AP or another STA device, to handle the session keep-alive messages or the IP address renewal messages on behalf of the STA device. Examples of these implementations are described below with reference to FIGS. 3-8.

FIG. 3 is a diagram that illustrates a procedure 300 for configuring offloads between STA device 302 and AP 304, according to some implementations. Here, the term “offload” may refer to a task handled by STA device 302 with the assistance of AP 304 to maintain continuity. In the context of this disclosure, the offloads include wakeup schedule and session information that an STA device may offload to AP 304 before deep sleep.

At 312, STA device 302 associates with AP 304, e.g., by sending an association request to AP 304 and receiving an association response from AP 304. Along with the association signaling, STA device 302 negotiates with AP 304 about offload configurations by exchanging one or more information elements (IEs). In some implementations, the IEs indicate one or more of: a category of STA device 302, a subcategory of STA device 302, or an offload configuration. As an example, a category with a value of 4 indicates that STA device 302 is a camera. In this category, a subcategory with a value of 5 indicates that STA device 302 is a rear-view camera (e.g., rear view camera 112) for a trailer truck while a subcategory with a value of 6 indicates that STA device 302 is a security camera (e.g., security camera 128) in a smart home security system. As another example, a category with a value of 3 indicates that STA device 302 is a printer. In this category, a subcategory with a value of 5 indicates that STA device 302 is an all-in-one printer.

Each category and subcategory combination correspond to a set of offloads, which may be indicated in a bitmap of an IE. For example, an IE with category=4 and subcategory=5 may indicate one or more offloads from: TCP keep-alive (TCPKA), DHCP lease time renew (DLTR), or L2 keep-alive (L2KA). Also, an IE with category=4 and subcategory=6 may indicate one or more offloads from: TCPKA, Transport Layer Security (TLS) Session keep alive, Group Transient Key (GTK) rotation. Also, an IE with category=3 and subcategory=5 may indicate one or more offloads from: TCPKA, DLTR, or multicast domain name system (mDNS) printer service query response. By transmitting one or more IEs to AP 304, STA device 302 requests AP 304 to assist with handling the indicated offloads. In return, AP 304 responds to indicate that AP 304 will provide the assistance as requested.

After the association and negotiation between STA device 302 and AP 304, STA device 302 establishes a communication session with server 306 at 314. As such, server 306 expects STA device 302 to regularly exchange keep-alive messages according to the communication session and/or the tasks executed by STA device 302 to maintain continuity.

At 316, STA device 302 enters the deep sleep mode. Meanwhile, AP 304 manages one or more timers and, at 318, wakes STA device 302 up from the deep sleep mode.

At 320, STA device 302, waken up by AP 304, exchanges keep-alive messages with server 306 to maintain continuity of the communication session and/or the tasks. STA device 302 may return to deep sleep afterwards.

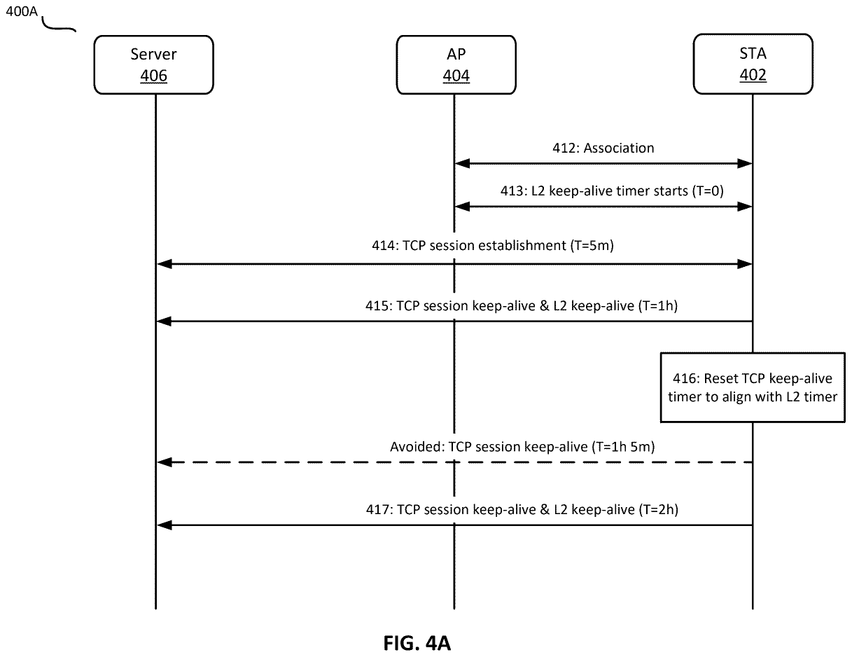

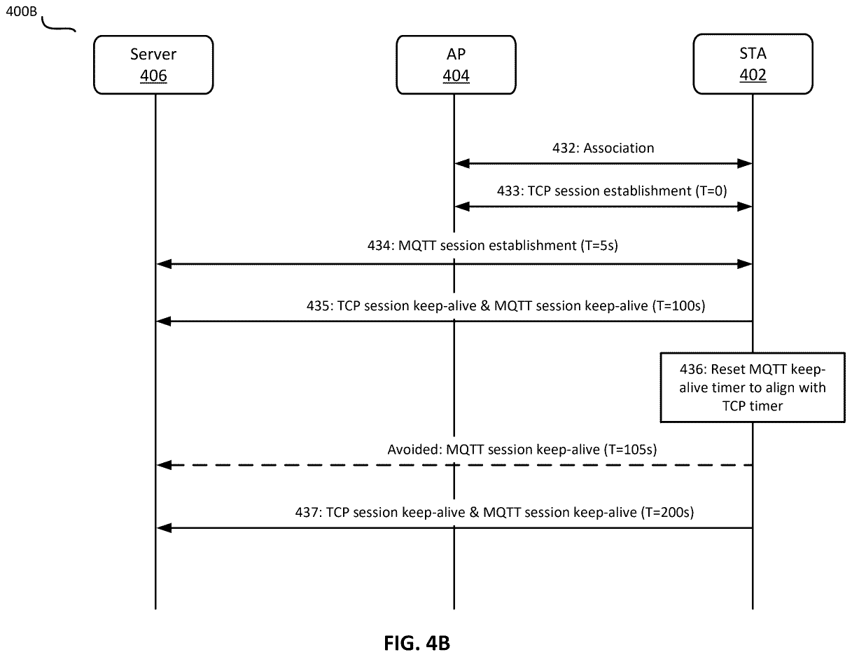

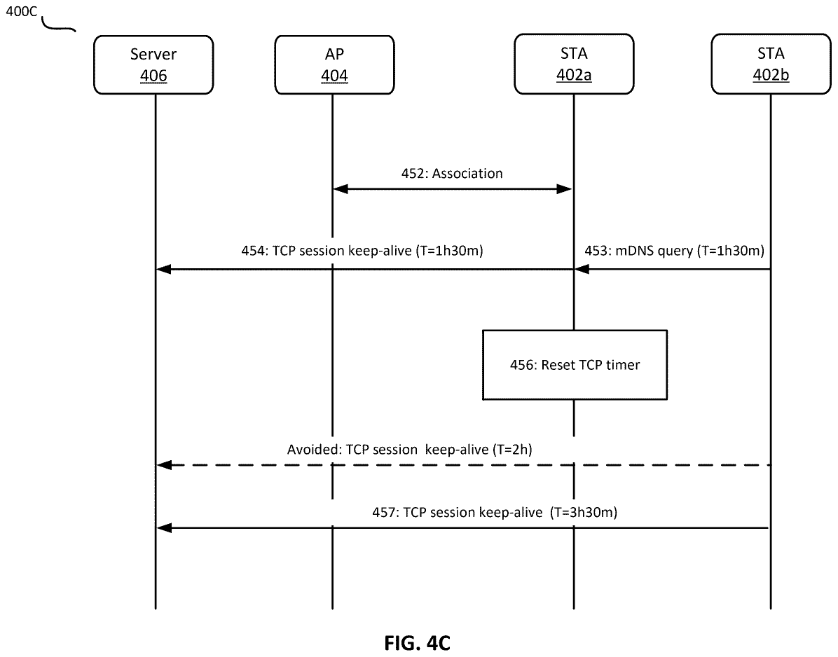

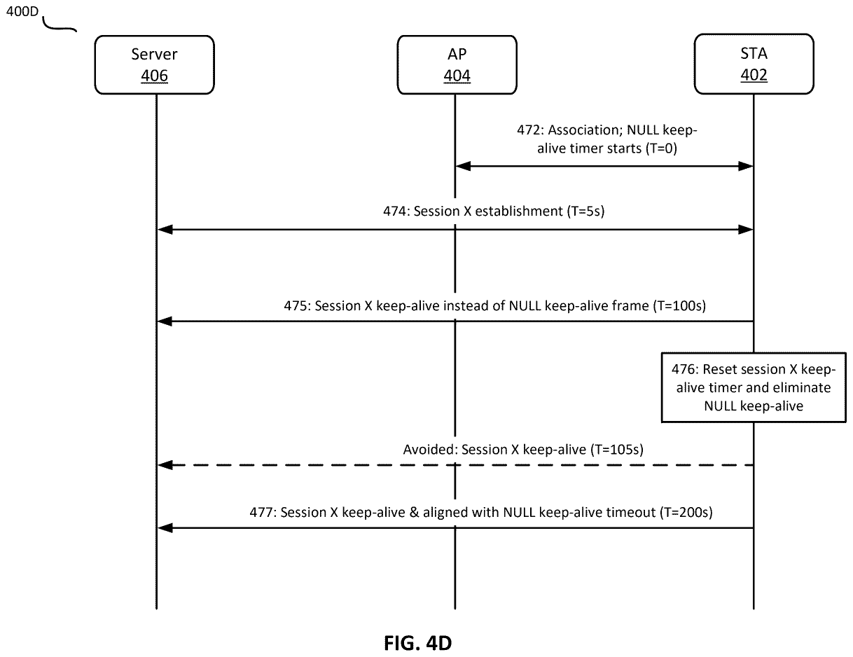

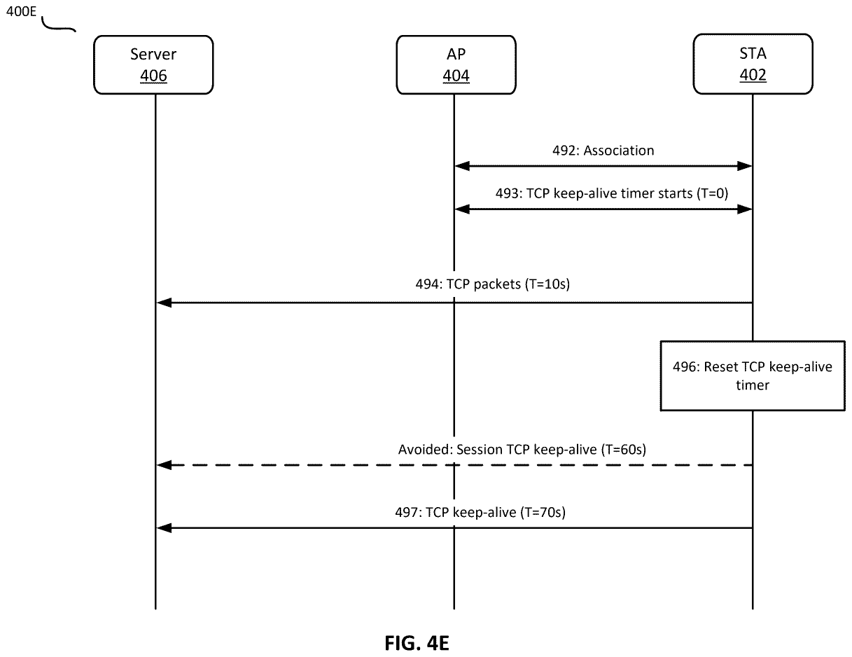

Procedure 300 may be more power efficient than existing techniques in that, by having AP 304 manage the timers and wake STA device 302 up, STA device 302 itself consumes less power managing the timers while in deep sleep. While such improvement in power efficiency is desirable, it is possible that some APs do not support the offloads as requested by the STA device during the negotiation. In such cases, the STA device may have to wake up periodically according to the timers. Still, some implementations provide a mechanism to improve power efficiency by reducing the total number of wake-ups, as described with reference to FIGS. 4A-4E.

FIGS. 4A-4E are diagrams that each illustrate a procedure for power saving based on alignment of triggering events, according to some implementations. In procedures 400A-400E of FIGS. 4A-4E, the triggering events may be expiration of a timer that STA device 402 manages while in deep sleep, or may be a network event, such as reception or transmission of a signal, that causes STA device 402 to wake up.

In FIG. 4A, procedure 400A may apply to a scenario where STA device 402, which is a rear-view camera, communicates with AP 404 in a trailer truck via a TCP session. As illustrated, STA device 402 associates with AP 404 at 412. At 413, the association causes a L2 keep-alive timer to start at time T=0, with the timer set to expire in 1 hour (h).

At 414, STA device 402 establishes the TCP session with server 406 at T=5 minutes (m). To maintain continuity, server 406 expects STA device 402 to send a session keep-alive message every one hour. To this end, prior to entering the deep sleep mode, STA device 402 may start a TCP keep-alive timer at T=5 m and set the timer to expire one hour later at 1 h 5 m.

When T=1 h, the L2 keep-alive timer expires, which triggers STA device 402 to wake up and prepare to transmit an L2 keep-alive message. At the same time, the TCP keep-alive timer is still running and is set to expire in 5 minutes.

STA device 402 may determine that the remaining 5 minutes of the TCP keep-alive timer is relatively short, e.g., shorter than a threshold. Based on this determination, STA device 402 decides to preemptively transmit the TCP session keep-alive message without waiting another 5 minutes. Accordingly, at T=1 h, STA device 402 transmits both the L2 keep-alive message and the TCP session keep-alive message together to server 406 at 415. Along with the transmission, STA device 402 resets the unexpired TCP keep-alive timer at 416 such that both the TCP keep-alive timer and the L2 keep-alive timer are aligned and synchronized. This way, STA device 402 does not need to wake up once again at T=1 5 m according to the initially set TCP keep-alive timer. Rather, at T=2 h, both timers expire, causing STA device 402 again to wake up to transmit both the L2 keep-alive message and the TCP session keep-alive message together at 417. As such, the L2 keep alive message transmission can be eliminated now.

Compared to existing techniques, procedure 400A reduces the number of wake-ups and allows STA device 402 to have longer deep sleeps. The reduction of number of wake-ups further reduces the number of transmissions of messages, which in turn improves power efficiency.

In FIG. 4B, procedure 400B may apply to a scenario where STA device 402, which is a security camera, communicates with AP 404 in a smart home security system via an MQTT session established based on a TCP session. As illustrated, STA device 402 associates with AP 404 at 432.

At 433, STA device 402 and AP 404 establish the TCP session. The establishment of the TCP session causes a TCP keep-alive timer to start at time T=0, with the timer set to expire in 100 seconds(s).

At 434, STA device 402 and AP 404 establishes the MQTT session 5 seconds after the establishment of the TCP session. The establishment of the MQTT session causes an MQTT keep-alive timer to start at time T=5 s, with the timer set to expire 100 s later at T=105 s.

When T=100 s, the TCP keep-alive timer expires, which triggers STA device 402 to wake up and prepare to transmit a TCP session keep-alive message. At the same time, the MQTT keep-alive timer is still running and is set to expire in 5 seconds.

STA device 402 may determine that the remaining 5 seconds of the MQTT keep-alive timer is relatively short, e.g., shorter than a threshold. Based on this determination, STA device 402 decides to preemptively transmit the MQTT session keep-alive message without waiting another 5 seconds. Accordingly, at T=100 s, STA device 402 transmits both the TCP session keep-alive message and the MQTT session keep-alive message together to server 406 at 435. Along with the transmission, STA device 402 resets the unexpired MQTT keep-alive timer at 436 such that both the TCP keep-alive timer and the MQTT keep-alive timer are aligned and synchronized. This way, STA device 402 does not need to wake up once again at T=105 s according to the initially set MQTT keep-alive timer. Rather, at T=200 s, both timers expire, causing STA device 402 again to wake up to transmit both the MQTT keep-alive message and the TCP session keep-alive message together at 437. Similar to procedure 400A, procedure 400B improves power efficiency by reducing the number of wake-ups of STA device 402.

In FIG. 4C, procedure 400C involves two STA devices, 402a and 402b. At 452, STA device 402a, which may be a network printer, associates with AP 404. Assuming STA device 402a starts a TCP keep-alive timer at T=0 to support a TCP session that expects a keep-alive message every 2 hours, STA device 402a enters deep sleep and is initially set to wake up by the TCP keep-alive timer at T=2 h.

At 453, STA device 402a receives an mDNS query message at T=1 h30 m from STA device 402b, which may send a printing job to STA device 402a. The mDNS query message triggers STA device 402a to wake up to process the query, even though the TCP keep-alive timer is still running and has 30 minutes remaining before expiration.

STA device 402 may determine that the remaining 30 minutes of the TCP keep-alive timer is relatively short, e.g., shorter than a threshold. Based on this determination, STA device 402 decides to preemptively transmit the TCP session keep-alive message to server 406 at 454 without waiting another 30 minutes. Accordingly, at T=1 h 30 m, STA device 402 transmits the TCP session keep-alive message contemporaneously with the processing of the mDNS query. STA device 402 further resets the TCP keep-alive timer such that the TCP keep-alive timer is now expected to expire in two hours at T=3 h 30 m, instead of in just 30 minutes at T=2 h. This way, procedure 400C improves the power efficiency of STA device 402a by allowing STA device 402 to stay in the deep sleep mode for longer.

In FIG. 4D, STA device 402 associates with AP 404 at 472. The association causes a NULL keep-alive timer to start at time T=0, with the timer set to expire in 100 s.

At 474, STA device 402 establishes an X session with AP 404 and starts an X keep-alive timer at time T=5 s, with the timer set to expire 100 seconds later at T=105 s.

When T=100 s, the NULL keep-alive timer expires, which triggers STA device 402 to wake up and prepare to transmit a NULL keep-alive message (e.g., a NULL data frame). At the same time, the X keep-alive timer is still running and is set to expire in 5 seconds.

STA device 402 may determine that the remaining 5 seconds of the X keep-alive timer is relatively short and thus decide to preemptively process the upcoming session X keep-alive. Assuming that transmitting an X session keep-alive message serves the function of transmitting a NULL keep-alive message, STA device 402 may transmit, at time T=100 s, the X session keep-alive message instead of the NULL keep-alive message to server 406 at 475. With the transmission, STA device 402 resets the X keep-alive timer and eliminates the NULL keep-alive timer at 476. This way, STA device 402 no longer needs to wake up again at T=105 s but may remain in deep sleep until T=200 s when the X keep-alive timer again expires.

In FIG. 4E, STA device 402 associates with AP 404 at 492 and starts a TCP keep-alive timer corresponding to a TCP session at a time T=0 at 493.

At 494, upon a triggering event, STA device 402 wakes up to transmit one or more TCP packets to server 406 at T=10 s. Assuming server 406 considers TCP packets effectively as a keep-alive indication from STA device 402, STA device 402 decides to reset the TCP keep-alive timer at 496. This way, STA device 402 may remain in deep sleep until T=70 s instead of waking up at T=60 s as initially set.

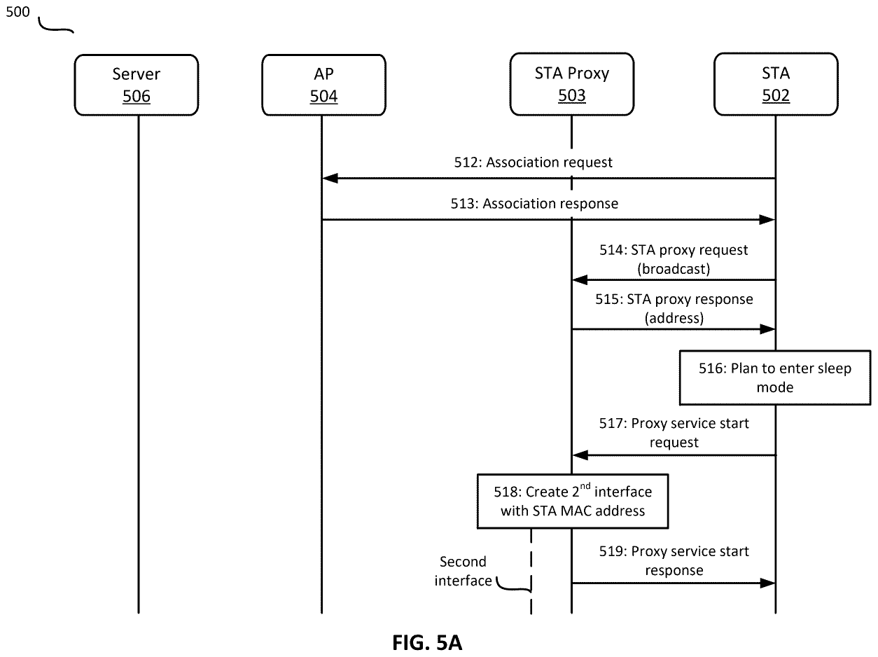

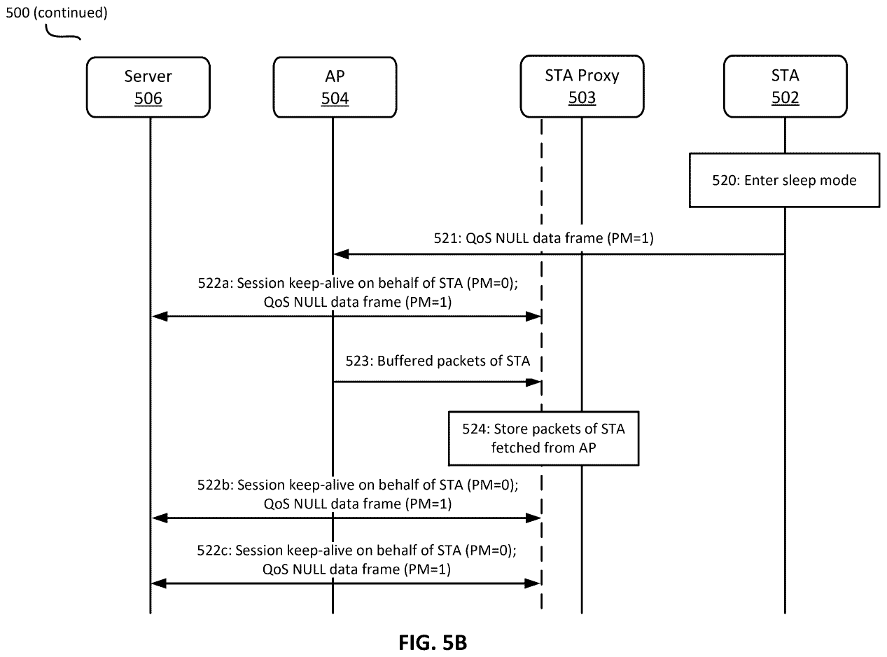

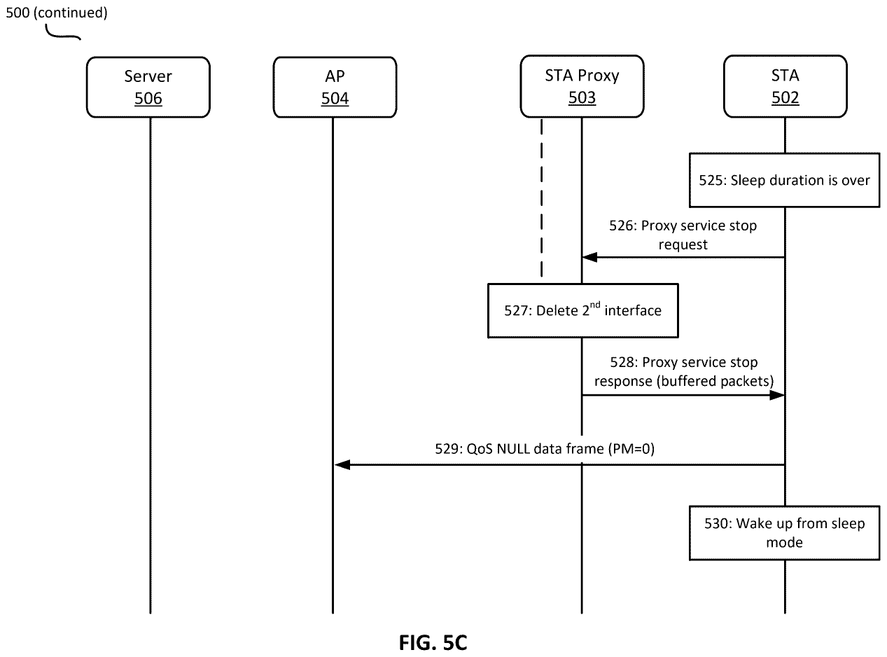

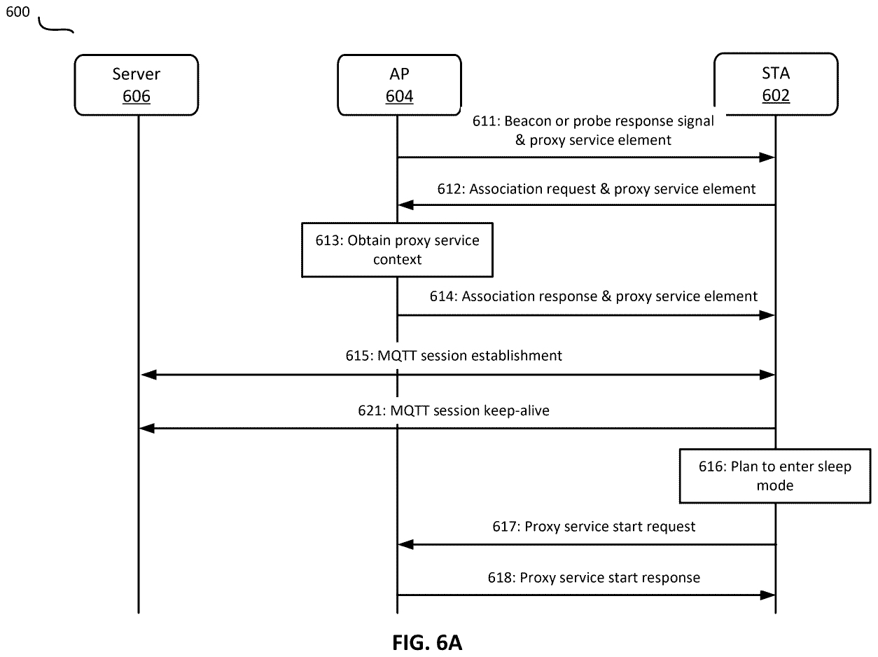

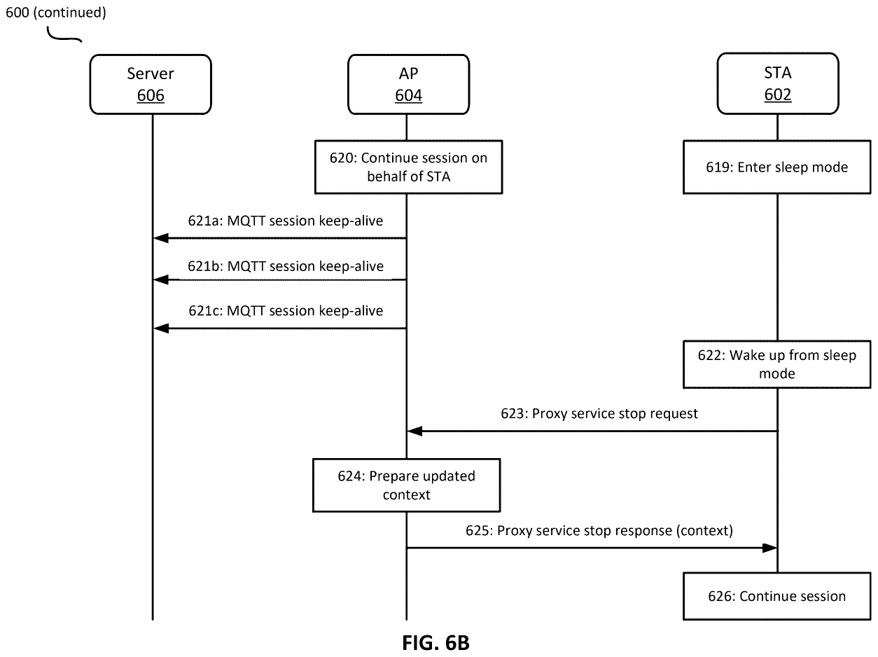

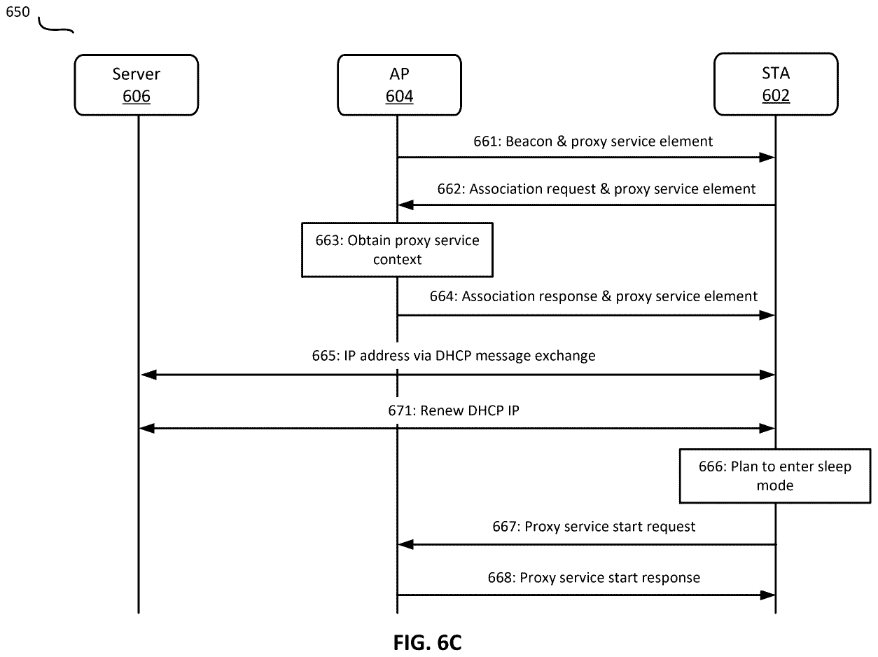

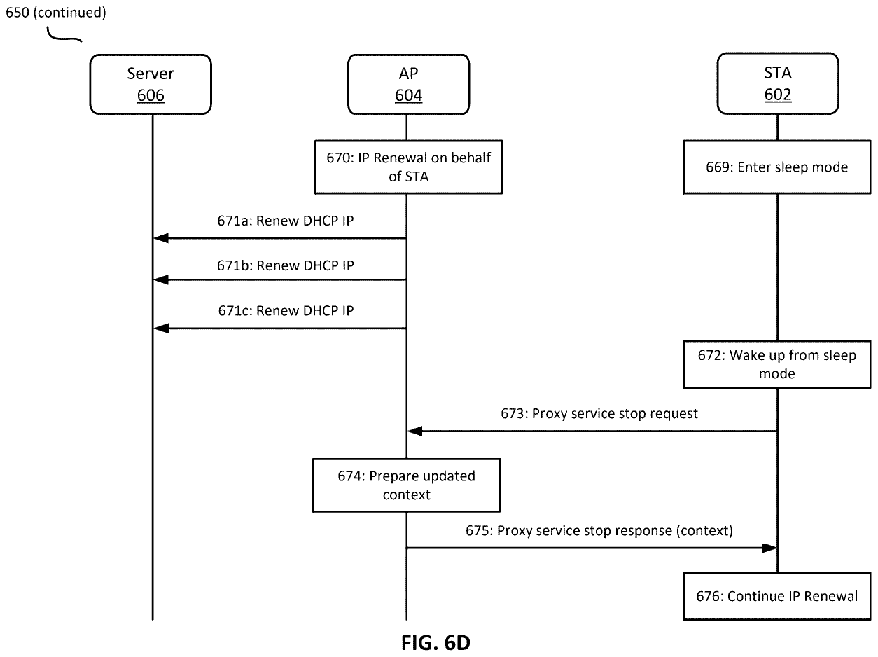

In some implementations, the power efficiency of an STA device may be improved by having a provider of proxy service handle the handshakes for continuity maintenance, e.g., transmission of keep-alive messages or renewal of IP leases, on behalf of the STA device. Examples implementations are described below with reference to FIGS. 5A-5C and 6A-6D.

FIGS. 5A-5C are diagrams that together illustrate procedure 500 of providing a proxy service to STA device 502, according to some implementations. In procedure 500, the provider of the proxy service is STA proxy device 503, which may be in the same network as STA device 502. Compared to STA device 502, STA proxy device 503 has more stable and adequate power supply. For example, STA proxy device 503 may be connected to a power outlet on infrastructure (e.g., a wall) whereas STA device 502 may be powered by a battery with a limited amount of power storage.

As illustrated, procedure 500 begins with STA device 502 sending an association request to AP 504 at 512 and receiving an association response from AP 504 at 513. After the association, STA device 502 may establish a session to communicate with server 506 via AP 504.

At 514, STA device 502 broadcasts an STA proxy request message (e.g., one or more frames) to other devices, e.g., devices surrounding STA device 502, to request utilizing a proxy service. In the STA proxy request message, STA device 502 may indicate information about the requested proxy service, such as the session type, time, duration, and identification of AP 504 and/or server 506.

At 515, STA proxy device 503 receives the STA proxy request message from STA device 502 and sends an STA proxy response message to STA device 502, e.g., to indicate the capability and availability of STA proxy device 503 for the requested proxy service. For example, STA proxy device 503 may accept STA device 502's request to provide proxy service, or may negotiate with STA device 502 about the session, time, or duration covered by the proxy service. STA proxy device 503 may include a network address of STA proxy device 503 in the STA proxy response message.

At 516, STA device 502 plans to enter the deep sleep mode. To maintain continuity of the session, STA device 502 sends a proxy service start request message to STA proxy device 503 at 517. The proxy service start request message may indicate that STA device 502 is about the enter the deep sleep mode and request STA proxy device 503 to handle the handshake with server 506 on behalf of STA device 502 to maintain continuity of the session. STA device 502 may provide one or more packets needed for the proxy service, and/or may specify, e.g., the duration of the proxy service, the interval of handshake messages, the IP address of server 506, etc.

At 518, in response to the proxy service start request message, STA proxy device 503 creates a second interface (e.g., in addition to a first interface that STA proxy device 503 uses for its own communication sessions with a server via AP 504) using the medium access control (MAC) address of STA device 502 for communicating with server 506. For example, in outbound messages to server 506, STA proxy device 503 may use the MAC address of STA device 502 as the source address.

Before, during, or after the creation of the second interface, STA proxy device 503 sends a proxy service start response message to STA device 502 at 519, e.g., to acknowledge the proxy service start request message and indicate whether STA proxy device 503 accepts STA device 502's request to start the proxy service, whether STA proxy device 503 is ready to handle the handshake with server 506 on behalf of STA device 502 as requested, and/or the duration of the proxy service that STA proxy device 503 agrees to provide.

In response to receiving the proxy service start response message that indicates STA proxy device 503 has agreed and is ready to start the proxy service, STA device 502 enters the deep sleep mode at 520. While entering the deep sleep mode, STA device 502 sends a quality of service (QoS) NULL data frame to AP 504. In the QoS NULL data frame, STA device 502 may indicate that a mode of power management (PM) of STA device 502 e.g., PM=1.

At 522a, STA proxy device 503 handshakes with server 506 according to the proxy service requested by STA device 502 and accepted by STA proxy device 503. For example, STA proxy device 503 sends, via AP 504 and using the second interface, a session keep-alive message, pretending that the session keep-alive message is sent from STA device 502. STA proxy device 503 may send the session keep-alive message with an indication of PM=0. In some implementations, the session keep-alive message is followed by a QoS NULL data frame with PM=1 to indicate to AP 504 that STA device 502 is going to sleep.

At 523, STA proxy device 503 uses the second interface to fetch packets buffered in AP 504. The fetched packets may be part of the messages communicated with STA device 502 before STA device 502 enters deep sleep. For example, the fetched packets indicate the context (e.g., history, current status, expected response, etc.) of the communication session. At 524, STA proxy device 503 stores the fetched packets in a buffer of STA proxy device 503.

At 522b and 522c, STA proxy device 503 continues to handshake with server 506 on behalf of STA device 502, e.g., by repeating the operations at 522a. STA proxy device 503 may keep providing the proxy service until the sleep duration of STA device 502 is over at 525. As STA proxy device 503 communicates with server 506 on behalf of STA device 502, STA proxy device 503 may update the buffered packets to reflect the latest context of the session.

When STA device 502 is about to exit the deep sleep mode, STA device 502 sends a proxy service stop request message to STA proxy device 503 at 526. In response to the proxy service stop request message, STA proxy device 503 deletes the second interface at 527 and stops providing the proxy service to STA device 502. As part of stopping the proxy service, STA proxy device 503 may sends a proxy service stop response message to STA device 502 at 528 to acknowledge the proxy service stop request message. The proxy service stop response message may include the packets fetched from AP 504 and buffered within STA proxy device 503.

At 529, STA device 502 sends a QoS NULL data frame with PM=0 to AP 504, e.g., to indicate that STA device 502 is back to full power mode. At 530, STA device 502 wakes up and takes over the communication session.

FIGS. 6A-6B are diagrams that together illustrate another procedure 600 of providing a proxy service to STA device 602, according to some implementations. In procedure 600, AP 604 serves as the provider of the proxy service to STA device 602.

At 611, AP 604 sends a beacon or a probe response signal to STA device 602. The beacon includes a proxy service element that indicates, e.g., the capability and availability of AP 604 as a proxy service provider.

At 612, STA device 602 sends an association request to AP 604. The association request may be accompanied with or include a request to utilize the proxy service by STA device 602. Along with the association request, STA device 602 negotiates with AP 604 about the proxy service that STA device 602 requests AP 604 to provide. Based on an agreement between AP 604 and STA device 602, AP 604 obtains, at 613, context information about the session for which AP 604 agrees to provide proxy service.

At 614, AP 604 sends an association response to STA device 602 to acknowledge the association request. AP 604 may include a proxy service element to reflect the outcome of the proxy service negotiation.

At 615, STA device 602 establishes an MQTT session with server 606. STA device 602 then communicates with server 606 in the MQTT session and may periodically handshake with server 606 by sending one or more MQTT session keep-alive messages at 621.

At 616, STA device 602 plans to enter the deep sleep mode. Accordingly, at 617, STA device 602 sends a proxy service start request message to AP 604 at 617 along with session information and other data, and AP 604 sends a proxy service start response message to STA device 602 at 618. The proxy service start response message may acknowledge the proxy service start request message and indicate that AP 604 accepts STA device 602's request to start providing the proxy service. In response to the proxy service start response message, STA device 602 enters the deep sleep mode at 619.

Meanwhile, at 620, AP 604 maintains continuity of the session on behalf of STA device. As illustrated, AP 604 periodically transmits one or more MQTT session keep-alive messages to server 606 at 621a-621c. AP 604 may update the context of the communication session and store the updated context information.

At 622, STA device 602 decides to wake up from the deep sleep mode. As such, at 623, STA device 602 sends a proxy service stop request message to AP 604. In response, AP 604 prepares the updated context information at 624 and sends the updated context information in a proxy service stop response message to STA device 602 at 625. Based on the updated context information, STA device 602 continues the session at 626.

FIGS. 6C-6D are diagrams that together illustrate yet another procedure 650 of providing a proxy service to STA device 602, according to some implementations. Different from procedure 600 that is in the context of MQTT session keep-alive, procedure 650 is in the context of DHCP IP address renewal. In procedure 650, operations at 661-664, 666-669, and 672-675 are similar to operations at 611-614, 616-619, and 622-625 in procedure 600. Thus, descriptions of these operations in procedure 650 are omitted for brevity.

At 665, after STA device 602 associates with AP 604, STA device 602 obtains an IP address from server 606 by exchanging DHCP messages with server 606. At 665, STA device 602 periodically renews the DHCP IP address with server 606.

At 670, after STA device 602 enters the deep sleep mode and based on the agreement to provide proxy service, AP 604 handles IP renewal on behalf of STA device 602. As illustrated, AP 604 periodically renews the DHCP IP address with server 606 at 671a-671c to maintain continuity of the communication session.

At 676, after waking up from the deep sleep mode and obtaining updated context information from AP 604, STA device 602 takes over the communication session using the DHCP IP address and handles the renewal of the IP address on its own.

According to procedures 500, 600, and 650, an STA device is able to stay in the deep sleep mode for a longer duration of time than in existing techniques, due to the availability of a proxy service provider. As such, the STA device may have improved power efficiency.

Implementations in FIGS. 3 and 4A-4E may be combined with implementations in FIGS. 5A-5C and 6A-6D. For example, before entering the deep sleep mode, an STA device may inquire whether a proxy service provider is available in the network. If a proxy service provider is available, the STA device may have the proxy service provider handle the handshakes with the server to maintain continuity of a session, as described with reference to FIGS. 5A-5C and 6A-6D. Conversely, if a proxy service provider is unavailable, the STA device may handle the handshakes on its own, e.g., by waking up from the deep sleep mode, as described with reference to FIGS. 3 and 4A-4E.

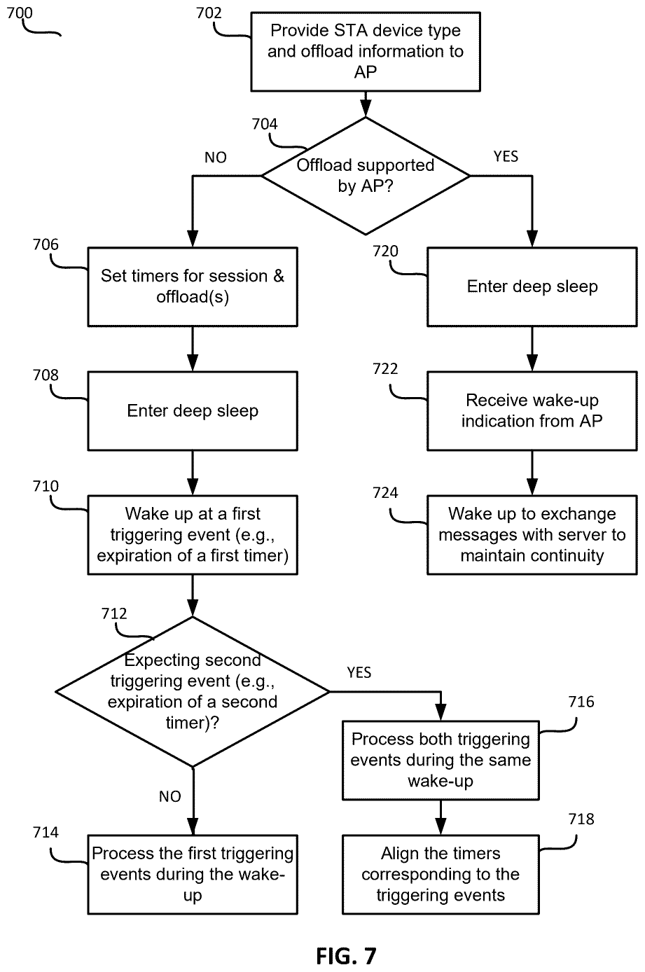

FIG. 7 is a flowchart that illustrates method 700 of power management in deep sleep based on triggering events, according to some implementations. Method 700 may be performed by an STA device, such as STA device 302 in FIG. 3 or STA device 402 in FIGS. 4A-4E. Some operations illustrated in FIG. 7 are similar to those described previously with reference to FIGS. 3 and 4A-4E.

At 702, the STA device provides STA device type information and offload information to an AP. The STA device may provide such information in an IE including, e.g., the category and the subcategory of the STA device, and/or the offloads corresponding to the category and the subcategory.

At 704, the STA device negotiates with the AP to determine whether the AP supports the offloads included in the IE. If the AP supports the offloads, method 700 proceeds to 720; otherwise, method 700 proceeds to 706.

At 706, because the AP does not support the offloads as requested, the STA device sets one or more timers based on the communication session and the tasks corresponding to the requested offloads.

At 708, the STA device enters the deep sleep mode with the timers running. The STA device is expected to wake up when each timer expires.

At 710, the STA device wakes up upon detecting a first triggering event. The first triggering event may be the expiration of a first timer, as described previously with reference to FIGS. 4A, 4B, and 4D, or may be the reception or transmission of a signal, as described previously with reference to FIGS. 4C and 4E.

At 712, the STA device determines whether there is a second triggering event (e.g., expiration of a second timer) expected to happen. If the answer is No, method 700 proceeds to 714 at which the STA device processes the first triggering event, e.g., by sending a keep-alive message. If the answer is Yes, method 700 proceeds to 716.

At 716, the STA device processes both the first and the second triggering events together during the same wake-up. For example, the STA device may send a first keep-alive message corresponding to the first triggering event and a second keep-alive message corresponding to the second triggering event together, even though the second triggering event has not occurred yet.

At 718, the STA device aligns the timers corresponding to the first and the second triggering events, e.g., by resetting the second timer. This way, the total number of wake-ups is reduced, and the STA device may have improved power efficiency.

If method 700 proceeds to the branch of 720 instead of the branch of 706, then the STA device enters deep sleep without setting own timers but expecting wake-up indications from the AP to maintain session continuity.

At 722, the STA device receives a wake-up indication from the AP. In response, at 724, the STA device wakes up and performs handshake with the server, e.g., by sending a session keep-alive message or by renewing a leased IP address.

It is noted that the operations in method 700 do not necessarily have to be performed in the order illustrated. For example, in some implementations, the operation at 718 may be performed prior to or at the same time as the operation at 716.

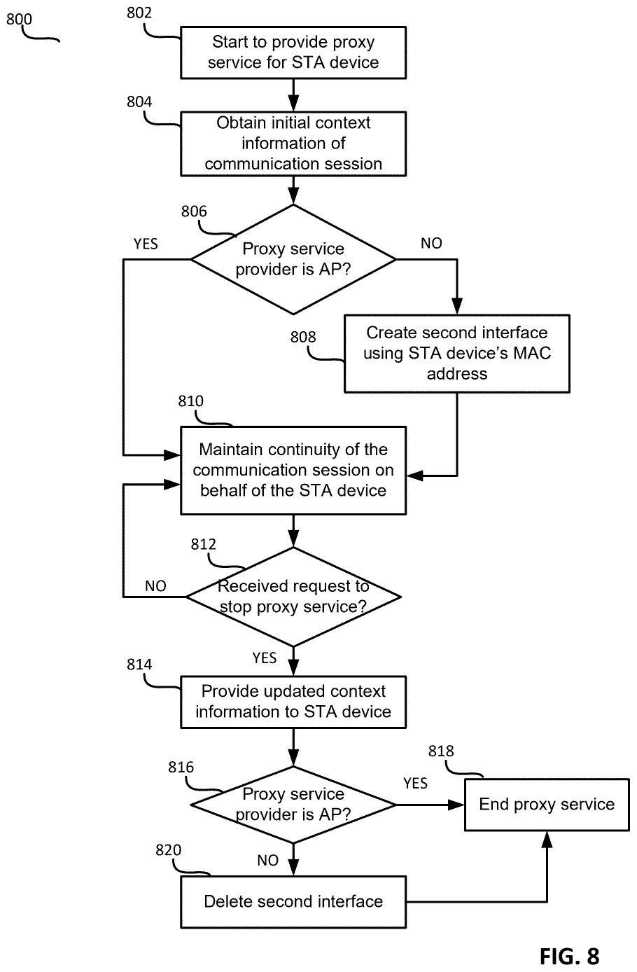

FIG. 8 is a flowchart that illustrates method 800 of providing a proxy service to an STA device, according to some implementations. Method 800 may be performed by a proxy service provider, which may be an AP (such as AP 604 in FIGS. 6A-6D) or an STA device (such as STA proxy device 503 in FIGS. 5A-5C. Some operations illustrated in FIG. 7 are similar to those described previously with reference to FIGS. 5A-5C and 6A-6D.

At 802, the proxy service provider starts to provide proxy service at the request of the STA device.

At 804, the proxy service provider obtains initial context information of a communication session between the STA device and a server. The proxy service provider may obtain the initial context information from an AP or from the STA device when the proxy service starts.

At 806, depending on whether the proxy service provider is an AP, method 800 proceeds to 808 or 810.

If the proxy service provider is not an AP, method 800 proceeds to 808 at which the proxy service provider creates a second interface using the MAC address of the STA device. Method 800 then proceeds to 810 at which the proxy service provider maintains continuity of the communication session on behalf of the STA device. Conversely, if the proxy service provider is an AP, method 800 proceeds to 810 without going through 808.

At 812, the proxy service provider monitors for a request from the STA device to stop the proxy service. The proxy service provider continues maintaining continuity of the communication session on behalf of the STA device at 810 until receiving the request to stop the proxy service.

At 814, upon receipt of the request to stop the proxy service, the proxy service provider provides updated context information to the STA device.

At 816, method 800 proceeds to 818 or 820 depending on whether the proxy service provider is an AP. If the proxy service provider is not an AP, then the proxy service provider deletes the second interface at 820 before ending the proxy service at 818. If the proxy service provider is an AP, then the proxy service provider directly proceeds to end the proxy service at 818.

It is noted that the operations in method 800 do not necessarily have to be performed in the order illustrated. For example, in some implementations, the operation at 804 may be performed prior to or at the same time as the operation at 802.

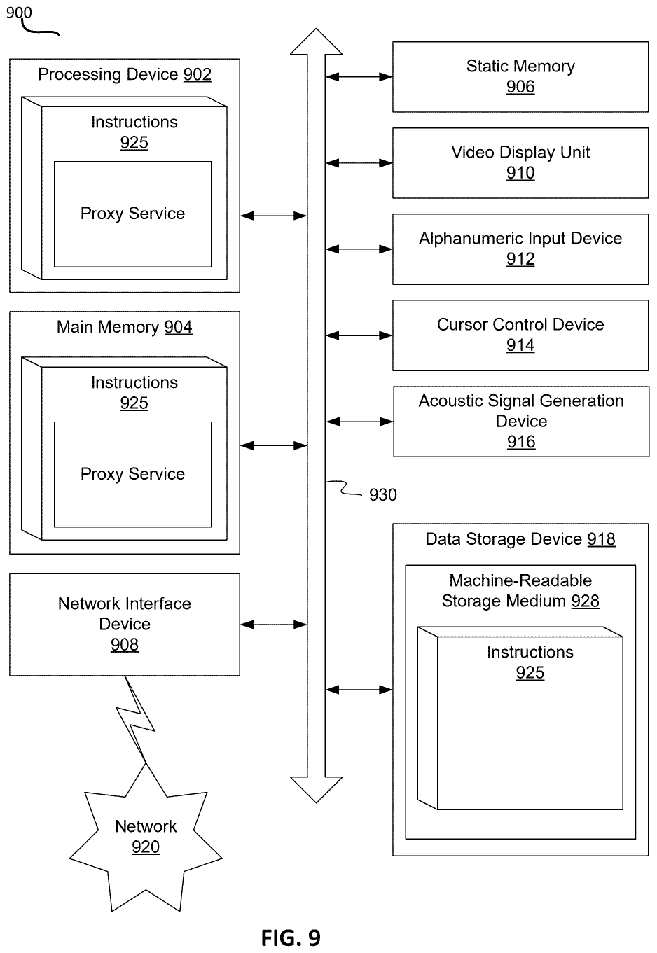

FIG. 9 is a block diagram of an example apparatus 900 that may perform one or more of the operations described herein, according to some implementations. Apparatus 900 may be implemented as a proxy service provider, such as STA proxy device 503 in FIGS. 5A-5E or AP 604 in FIGS. 6A-6D. Apparatus 900 may also be referred to as computing device 900.

Computing device 900 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 900 may include a processing device (e.g., a general purpose processor, a PLD, etc.) 902, a main memory 904 (e.g., synchronous dynamic random access memory (DRAM), read-only memory (ROM)), a static memory 906 (e.g., flash memory and a data storage device 918), which may communicate with each other via a bus 930.

Processing device 902 may be provided by one or more general-purpose processing devices such as a microprocessor, central processing unit, or the like. In an illustrative example, processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 902 may also comprise one or more special-purpose processing devices such as an application specific integrated circuit (ASIC), a field programmable gate array (FPGA), a digital signal processor (DSP), network processor, or the like. The processing device 902 may be configured to execute the operations described herein, in accordance with one or more aspects of the present disclosure, for performing the operations and steps discussed herein.

Computing device 900 may further include a network interface device 908 which may communicate with a network 920. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 916 (e.g., a speaker). In one embodiment, video display unit 910, alphanumeric input device 912, and cursor control device 914 may be combined into a single component or device (e.g., an LCD touch screen).

Data storage device 918 may include a computer-readable storage medium 928 on which may be stored one or more sets of instructions 925 that may include instructions for providing a proxy service, in accordance with one or more aspects of the present disclosure. Instructions 925 may also reside, completely or at least partially, within main memory 904 and/or within processing device 902 during execution thereof by computing device 900, main memory 904 and processing device 902 also constituting computer-readable media. The instructions 925 may further be transmitted or received over a network 920 via network interface device 908.

While computer-readable storage medium 928 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

In the above description, some portions of the detailed description are presented in terms of algorithms and symbolic representations of operations on signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

The description includes references to the accompanying drawings, which form a part of the detailed description. The drawings show illustrations in accordance with exemplary implementations. These implementations, which may also be referred to herein as “examples,” are described in enough detail to enable those skilled in the art to practice the implementations of the claimed subject matter described herein. The implementations may be combined, other implementations may be utilized, or structural, logical, and electrical changes may be made without departing from the scope and spirit of the claimed subject matter. It should be understood that the implementations described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “transmitting,” “obtaining,” “creating,” “determining,” “generating,” “providing,” “maintaining,” “charging,” or the like, refer to the actions and processes of an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such.

Implementations described herein may also relate to an apparatus (e.g., an AP or an STA device) having a processor and a memory, with the processor configured to execute instructions stored in the memory for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present implementations. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present implementations.

The above description sets forth numerous specific details such as examples of specific systems, components, methods, and so forth, in order to provide a good understanding of several implementations of the present disclosure. It is to be understood that the above description is intended to be illustrative and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, from a station (STA) device, a first request to start a proxy service for a communication session between the STA device and a server;
transmitting, to the STA device, a first response that acknowledges the first request;
obtaining, from the STA device, initial context information associated with the communication session; and
transmitting, to the server and on behalf of the STA device, a message that indicates continuation of the communication session.

2. The method of claim 1, further comprising:
receiving, from the STA device, a second request to stop the proxy service; and
transmitting, to the STA device, a second response that acknowledges the second request, the second response comprising updated context information associated with the communication session.

3. The method of claim 1, wherein the first request comprises the initial context information.

4. The method of claim 1, further comprising:
receiving, from the STA device, a third request to utilize the proxy service; and
transmitting, to the STA device, a third response to the third request, the third response comprising an address of a provider of the proxy service.

5. The method of claim 4, further comprising:
creating a communication interface based a medium access control (MAC) address of the STA device,
wherein transmitting the message on behalf of the STA device comprises transmitting the message using the communication interface.

6. The method of claim 4, wherein the provider comprises a wall-powered STA proxy device.

7. The method of claim 1, further comprising:
transmitting, to the STA device, a signal indicating a capability of a provider for the proxy service;
receiving, from the STA device, a fourth request to associate with the provider of the proxy service; and
transmitting, to the STA device, a fourth response that acknowledges the fourth request.

8. The method of claim 7, wherein the signal comprises at least one of: a beacon, or a probe response.

9. The method of claim 7, wherein the provider comprises an access point (AP).

10. The method of claim 1, wherein the message comprises at least one of: a keep-alive message, a null data frame, or a request to renew a network address assigned by the server.

11. An apparatus comprising:
a memory; and
a processing device operatively coupled to the memory, wherein the processing device is configured to:
receive, from a station (STA) device, a first request to start a proxy service for a communication session between the STA device and a server;
transmit, to the STA device, a first response that acknowledges the first request;
obtain, from the STA device, initial context information associated with the communication session; and
transmit, to the server and on behalf of the STA device, a message that indicates continuation of the communication session.

12. The apparatus of claim 11, wherein the processing device is further configured to:
receive, from the STA device, a second request to stop the proxy service; and
transmit, to the STA device, a second response that acknowledges the second request, the second response comprising updated context information
associated with the communication session.

13. The apparatus of claim 11, wherein the processing device is further configured to:
receive, from the STA device, a third request to utilize the proxy service; and
transmit, to the STA device, a third response to the third request, the third response comprising an address of the apparatus.

14. The apparatus of claim 13,
wherein the processing device is further configured to create a communication interface based on a medium access control (MAC) address of the STA device, and
wherein the processing device is further configured to transmit the message using the communication interface.

15. The apparatus of claim 11, wherein the processing device is further configured to:
transmit, to the STA device, a signal indicating a capability of the apparatus to provide the proxy service;
receive, from the STA device, a fourth request to associate with the apparatus; and
transmit, to the STA device, a fourth response that acknowledges the fourth request.

16. The apparatus of claim 15, wherein the signal comprises at least one of: a beacon or a probe response.

17. The apparatus of claim 11, wherein the message comprises at least one of: a keep-alive message, a null data frame, or a request to renew a network address assigned by the server.

18. A system comprising:
a station (STA) device in communication with a server; and
a provider of a proxy service,
wherein the provider is communicatively coupled to the STA device and configured to:
receive, from the STA device, a first request to start the proxy service for a communication session between the STA device and the server;
transmit, to the STA device, a first response that acknowledges the first request;
obtain, from the STA device, initial context information associated with the communication session; and
transmit, to the server and on behalf of the STA device, a message that indicates continuation of the communication session.

19. The system of claim 18, wherein the provider comprises a wall-powered STA proxy device, and wherein the provider is further configured to:
receive, from the STA device, a third request to utilize the proxy service; and
transmit, to the STA device, a third response to the third request, the third response comprising an address of the provider.

20. The system of claim 18, wherein the provider comprises an access point (AP), and wherein the provider is further configured to:
transmit, to the STA device, a signal indicating a capability of the provider;
receive, from the STA device, a fourth request to associate with the provider; and
transmit, to the STA device, a fourth response that acknowledges the fourth request.
